(19) United States
(12) Patent Application Publication
(10) Pub. No.: US 2006/0024102 A1
(43) Pub. Date: Feb. 2, 2006

(54) Image forming apparatus including waste toner reusing device and method of reusing waste toner

(75) Inventor: Hyun-Sun Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/129,506

(22) Filed: May 16, 2005

(30) Foreign Application Priority Data
Jul. 30, 2004 (KR) 2004-0060147

(51) Int. Cl. G03G 21/00

(52) U.S. Cl. 399/359

(57) ABSTRACT

An image forming apparatus is provided including a waste toner reusing device and a method of reusing waste toner. The image forming apparatus includes a photoreceptive unit, a waste toner container, and a waste toner reusing device. The waste toner container stores waste toner removed from at least one of the photoreceptive unit and an intermediate transfer medium. The waste toner reusing device reuses the waste toner stored in the waste toner container to develop a latent image formed on the photoreceptive unit. Therefore, the waste toner can be reused for operations such as print testing. Reusing waste toner prolongs the lifespan of toner, thus cutting costs.

### CROSS-REFERENCE TO RELATED APPLICATIONS

This application claims the benefit under 35 U.S.C. 119(a) of Korean Patent Application No. 10-2004-0060147, filed on Jul. 30, 2004, the entire disclosure of which is hereby incorporated by reference.

### BACKGROUND OF THE INVENTION

1. Field of the Invention:

The present invention relates to an image forming apparatus. More particularly, the present invention relates to an image forming apparatus that reuses waste toner removed from a photoreceptive unit for various operations such as test printing.

2. Description of the Related Art:

In general, an image forming apparatus operates in the following manner. First, a latent image is formed on a photoreceptive unit by an exposure unit, such as a laser scanning unit. The photoreceptive unit may be a photoreceptive drum or a photoreceptive belt. Next, the electrostatic latent image is developed by using toner. The developed toner image is then transferred onto a print medium and fused by heat and pressure to attain a desired image.

The toner image is transferred from the photoreceptive unit to the print medium using a difference in electrical potential between the photoreceptive unit and a transfer unit or alternatively between the transfer unit and the printing medium.

However, the toner image is not completely transferred from the photoreceptive unit to the transfer unit or from the transfer unit to the print medium. That is, some of the toner image remains on the photoreceptive unit and the transfer unit.

This waste toner hinders the next toner image from being transferred. As a result, a cleaning unit such as a cleaning blade, a cleaning roller, or the like is used to remove the waster toner. The removed waste toner is stored in a waste toner container.

When the waste toner container is completely filled with waste toner, the waste toner container is removed from a main body. Then, a new waste toner container is placed in the main body to collect the waste toner removed from the photoreceptive unit and the transfer unit.

The image forming apparatus includes developing units to store cyan (C), magenta (M), yellow (Y), and black (K), respectively. The image forming apparatus can form a monochromatic image or a color image.

In order to form a monochromatic image, the image forming apparatus uses the black (K) developing unit for the toner supply. In order to form a color image, the image forming apparatus uses the C, M, Y, K developing units. In the latter case, the toners overlap one another to form a desired color image.

Therefore, when a monochromatic image is formed, the waste toner removed from the photoreceptive unit and the transfer unit is black. Meanwhile, when a color image is formed, the waste toner removed from the photoreceptive unit and the transfer unit is a mixture of C, M, Y, and K colors. As a result, the color waste toner removed from the photoreceptive unit and the transfer unit may not be used again to form another color image. Therefore, the color waste toner is transferred to the waste toner container. Moreover the black toner collected in the waste toner container is mixed with collected color waste toner of a different color. Therefore, the black color is changed, making it difficult to reuse the black waste toner to form an image. In addition, when the waste toner container is removed from the main body, the waste toner may spill and contaminate a neighboring apparatus.

After the color image is formed, the color of the waste is brown. Therefore, although the brown waste toner cannot be used to form another color image, it can be used to check the image quality or for test printing. Therefore, by reusing the waste toner, the toner can be used for a long period.

Accordingly, there is a need for an improved image forming apparatus capable of reusing waste toner.

### SUMMARY OF THE INVENTION

An aspect of the present invention is to solve at least the above problems and/or disadvantages and to provide at least the advantages described below. Accordingly, an aspect of the present invention is to provide an image forming apparatus capable of reusing waste toner removed from a photoreceptive unit and a transfer unit.

According to an aspect of the present invention, there is provided an image forming apparatus having a photoreceptive unit and an intermediate transfer medium. The image forming apparatus includes a waste toner container for storing waste toner removed from at least one of the photoreceptive unit and the intermediate transfer medium. Additionally, the image forming apparatus includes a waste toner reusing device for reusing the waste toner stored in the waste toner container to develop a latent image formed on the photoreceptive unit.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a side-sectional view of an image forming apparatus including a waste toner reusing device in accordance with an embodiment of the present invention;

FIG. 2 is a configuration diagram of a waste toner reusing device in accordance with a first embodiment of the present invention; and

FIG. 3 is a configuration diagram of a waste toner reusing device in accordance with a second embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

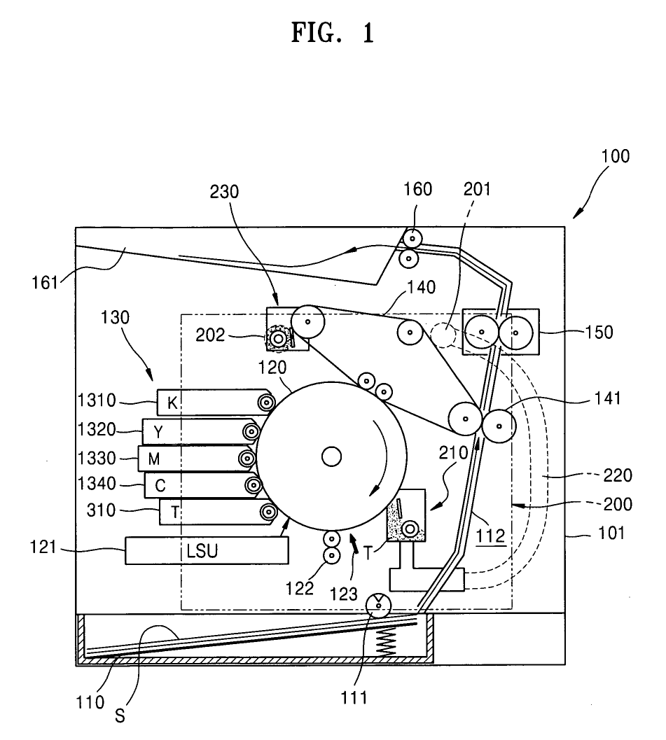

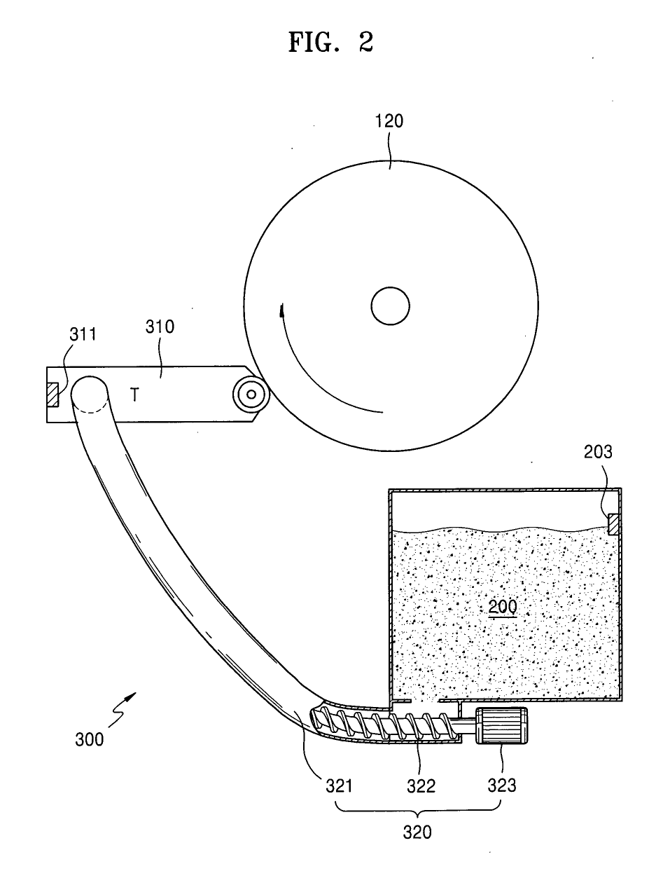

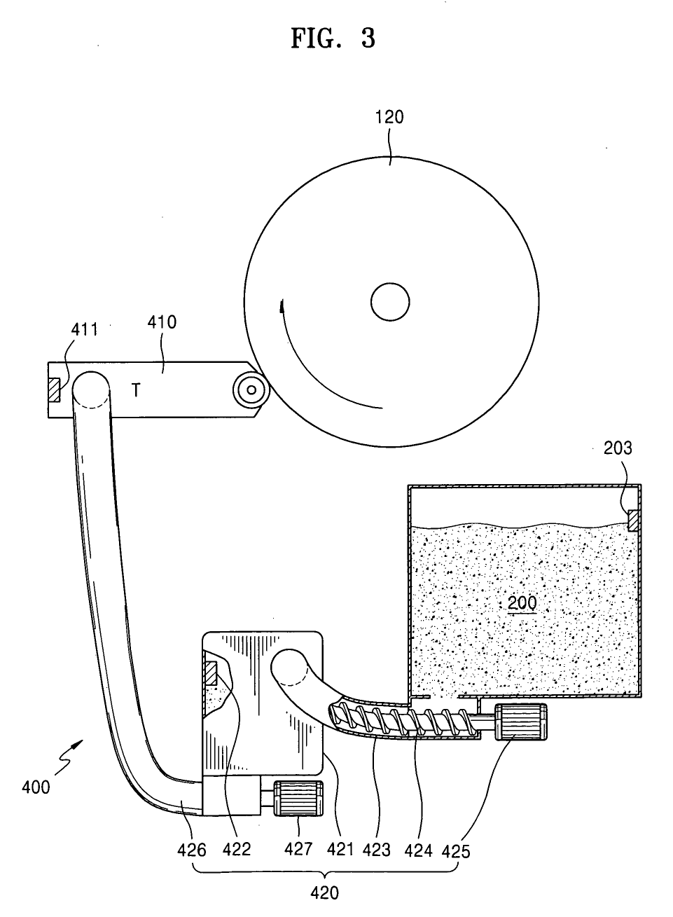

FIG. 1 is a side-sectional view of an image forming apparatus including a waste toner reusing device in accordance with an embodiment of the present invention. FIG. 2 is a configuration diagram of a waste toner reusing device in accordance with a first exemplary embodiment of the present invention. FIG. 3 is a configuration diagram of a waste toner reusing device in accordance with a second exemplary embodiment of the present invention.

Referring to FIG. 1, an image forming apparatus 100 includes a photoreceptive unit 120, a developing unit 130, an intermediate transfer medium 140, and a fixing unit 150. A cassette 110 on which a printing medium S is stored, is preferably located below the image forming apparatus 100. The cassette 110 may be affixed to or separated from the image forming apparatus 100. A pickup roller 111 is installed on the cassette 110 to pick up the printing medium S. The printing medium S picked up by the pickup roller 111 is transported along a transport passage 112 to form a desired toner image.

The photoreceptive unit 120 is a photoreceptive drum, which is preferably made by forming a photo-conductive material layer on an outer circumferential surface of a metal drum; however, other suitable arrangements and constructions maybe used such as a photoreceptive belt. A laser scanning unit 121 scans a light beam corresponding to image information onto the photoreceptive unit 120. The photoreceptive unit 120 is charged to have a uniform electrical potential. As a result, an electrostatic latent image is formed on a surface of the photoreceptive unit 120. Hereinafter, the photoreceptive unit 120 is referred to as the photoreceptive drum.

A charger 122 and a charge remover 123 are formed proximate to the photoreceptive drum 120. The photoreceptive drum 120 is charged by the charger 122 to have a uniform electrical potential. The charge remover 123 removes electric charges remaining on the photoreceptive drum 120.

The developing unit 130 includes four developing units 1310, 1320, 1330, and 1340 containing black (K) solid powder toner, yellow (Y) solid powder toner, magenta (M) solid power toner, and cyan (C) solid powder toner, respectively. The toner contained in each of the four developing units 1310, 1320, 1330, and 1340 is provided to the electrostatic latent image formed on the photoreceptive drum 120 to form a toner image. Meanwhile, when the electrostatic latent image is formed using the black (K) developing unit 1310, a monochromatic toner image is formed. On the other hand, when the electrostatic latent image is formed by overlapping colors of the four developing units 1310, 1320, 1330, and 1340, a color toner image is formed.

The intermediate transfer medium 140 receives the toner image from the photoreceptive drum 120, and then transfers the toner image to the printing medium S. A transfer belt is preferably used as the intermediate transfer medium 140; however, other suitable arrangements and constructions maybe used, such as a transfer drum.

The toner images of C, M, Y, and K formed on the photoreceptive drum 120 are transferred and overlap on the intermediate transfer medium 140 to form a color toner image. The intermediate transfer medium's 140 traveling linear velocity is preferably the same as a rotating linear velocity of the photoreceptive drum 120. The intermediate transfer medium 140 preferably has a length equal to or greater than that of the printing medium S so that the color toner image is transferred last.

A transfer roller 141 is formed on one side of the intermediate transfer medium 140. The transfer roller 141 is arranged so that it faces the intermediate transfer medium 140. The color toner image transferred from the photoreceptive drum 120 to the intermediate transfer medium 140. When this occurs, the transfer roller 141 separates from the intermediate transfer medium 140. However, when the transferring of the color toner image onto the intermediate transfer medium 140 is complete, the transfer roller 141 contacts the intermediate transfer medium 140 with a predetermined pressure to transfer the color toner image onto the printing medium S.

Then, the color toner image transferred onto the printing medium S is fused to the printing medium S by application of heat and pressure from the fixing unit 150. The printing medium S, to which the toner image is fused, passes through an exhaust roller 160 for placement onto a paper exhaust plate 161.

Hereinafter, an image forming process will be described using an image forming apparatus having the above-mentioned configuration.

In an image forming apparatus, a latent image formed on the photoreceptive drum 120 is developed using toners of cyan (C), magenta (M), Yellow (Y), and Black (K) colors. At this time, it is preferable that the C, M, Y and K toners are sequentially used. The developed latent images overlap onto the intermediate transfer medium 140 to form a color toner image. The color toner image is transferred onto the printing medium S and then fused to attain a desired color toner image.

When the laser scanning unit 121 scans a light image signal corresponding to image information of cyan (C) color onto the photoreceptive drum 120 charged with uniform electrical position, a portion onto which the light image beam is scanned has a low resistance. As a result, electrical charges affixed on an outer circumferential surface of the photoreceptive drum 120 separate from the photoreceptive drum 120. The loss of electrical charges causes a difference in electrical position between a portion of the photoreceptive drum 120 that is exposed to the light image beam and a portion of the photoreceptive drum 120 that is not exposed to the light image beam. Therefore, an electrostatic latent image is formed on the outer circumferential surface of the photoreceptive drum 120.

The electrostatic latent image approaches the developing unit 1340 when the photoreceptive drum 120 rotates. Thus, the cyan (C) toner contained in the developing unit 1340 attaches to the electrostatic latent image to form a cyan toner image. Next, when the cyan toner image approaches the intermediate transfer medium 140 while the photoreceptive drum 120 rotates, the toner image is transferred onto the intermediate transfer medium 140 by an electrical potential difference and/or contact pressure between the photoreceptive drum 120 and the intermediate transfer medium 140. After the cyan toner image is completely transferred onto the intermediate transfer medium 140; magenta, yellow, and black toner images are sequentially transferred and overlap onto the intermediate transfer medium 140 in the above-mentioned manner to form a color toner image. The color toner image is transferred onto a printing medium S when the printing medium S passes between the intermediate transfer medium 140 and a transfer roller 141. The color toner image transferred onto the printing medium S is subjected to heat and pressure by the fixing unit 150. As a result, the color toner image is fused to the printing medium S. The fused color toner image is discharged to complete the color image forming process.

However, when the toner image is transferred from the photoreceptive drum 120 to the intermediate transfer medium 140, and subsequently from the intermediate transfer belt 140 to the printing medium S, the toner is not completely transferred. In other words, the toner remains on the photoreceptive drum 120 or on the intermediate transfer medium 140.

The image forming apparatus 100 includes cleaning units 210 and 230, a transporting unit 220, and a waste toner container 200. The cleaning units 210 and 230 remove waste toner remaining on the photoreceptive drum 120 and the intermediate transfer medium 140, respectively. The waste toner removed by the cleaning units 210 and 230 is transported by the transporting unit 220. The waste toner transported by the transporting unit 220 is stored in the waste toner container 200.

The waste toner container 200 is preferably arranged on a side surface of a main body 101 and removable. Injection entrances 201 and 202, through which the waste toner is injected, are connected to an upper portion of the waste toner container 200. Waste toner removed from the intermediate transfer medium 140 by the cleaning unit 230 directly passes through the injection entrance 202 and is then stored in the waste toner container 200.

On the other hand, waste toner removed from the photoreceptive drum 120 by the cleaning unit 210 is first transported to the waste toner container 200. Then the waster toner travels through the waste toner transporting unit 220 because the injection entrance 201 is positioned higher than the cleaning unit 210. When a monochromatic toner image is formed on the photoreceptive drum 120, the waste toner removed by the cleaning unit 210 is black. When a color toner image is formed on the photoreceptive drum 120, the waste toner removed by the cleaning unit 210 is a color mixture.

Referring to FIG. 2, the image forming apparatus 100 further includes a waste toner reusing device 300 in accordance with a first embodiment of the present invention.

The waste toner reusing device 300 is used to reuse waste toner stored in the waste toner container 200 to print an image. The waste toner reusing device 300 includes a waste toner developing unit 310 and a transporting unit 320.

Like the developing units 1310, 1320, 1330, and 1340, the waste toner developing unit 310 is positioned around a photoreceptive drum 120 and below a C developing unit 1340. The waste toner is provided to an electrostatic latent image formed on the photoreceptive drum 120 to form an image. The basic configuration of the waste toner developing unit 310 is the same as that of the development units 1310, 1320, 1330, and 1340.

The waste toner developing unit 310 preferably includes a sensor 311 therein to measure an amount of the waste toner stored.

The waste toner stored in the waste toner container 200 is transported to the waste toner developing unit 310 by the transporting unit 320. The transporting unit 320 connects the waste toner container 200 to the waste toner developing unit 310. The transporting unit 320 includes a connecting unit 321 and a driving unit 323. The connecting unit 321 preferably has a screw 322 to transport the waste toner. The driving unit 323 rotates the screw 322.

The waste toner container 200 includes a sensor 203, which measures the amount of the waste toner stored therein. The sensors 203 and 311 and the driving unit 323 are connected to a controlling unit (not shown).

The waste toner reusing device in accordance with the first embodiment of the present invention operates in the following manner.

Referring to FIG. 2, the sensor 203 measures the amount of the waste toner stored in the waste toner container 200. When the amount of the waste toner reaches a predetermined amount, the driving unit 323 is operated by the controlling unit (not shown). As a result, the screw 322 rotates, thus transporting the waste toner to the waste toner developing unit 310.

When the amount of the waste toner stored in the waste toner developing unit 310 exceeds a predetermined amount, the sensor 311 senses the excess of toner. Then, the driving unit 323 is stopped by the controlling unit (not shown), thus halting the transfer of the waste toner.

The electrostatic latent image formed on the photoreceptive drum 120 is developed using the waste toner developing unit 310 in the same manner as described with reference to developing units 1310, 1320, 1330, and 1340. The developing process of the waste toner developing unit 310 is not illustrated in the drawings.

Referring to FIG. 3, a waste toner reusing device 400 in accordance with a second embodiment of the present invention is used to reuse waste toner stored in the waste toner container 200 to print an image. The waste toner reusing device 400 includes a waste toner developing unit 410 and a transporting unit 420.

Like developing units 1310, 1320, 1330, and 1340, the waste toner reusing unit 410 is positioned around a photoreceptive drum 120 and below the C developing unit 1340. The waste toner is provided to an electrostatic latent image formed on a photoreceptive drum 120 to form an image. The basic configuration of the waste toner developing unit 410 is the same as that of the development units 1310, 1320, 1330, and 1340.

The waste toner developing unit 410 includes a sensor 411 to measure an amount of the waste toner stored.

The waste toner stored in the waste toner container 200 is transported to the waste toner developing unit 410 by the transporting unit 420. The transporting unit 420 includes connecting units 423 and 426, driving units 425 and 427, and a temporary waste toner container 421. The connecting units 423 and 426 connect the waste toner container 200 to the waste toner developing unit 410. The connecting units 423 and 426 preferably have a screw 424 therein to transport the waste toner. The driving units 425 and 427 rotate the screw 424. The temporary waste toner container 421 is interposed between the connecting units 423 and 426 and temporarily stores the waste toner transported from the waste toner container 200.

The temporary waste toner container 421 has a sensor 422. The waste toner container 200 has a sensor 203. Therefore, the sensor 422 measures waste toner stored in the temporary waste toner container 421, and the sensor 203 measures waste toner stored in the waste toner container 200. The sensors 203, 411, and 422 and driving units 425 and 427 are connected to a controlling unit (not shown).

The use of the temporary waste toner container 421 may prevent the waste toner container 200 from overflowing. In detail, when a large amount of the waste toner is stored in the waste toner container 200, some of the waste toner is temporarily stored in the temporary waste toner container 421.

The waste toner reusing device in accordance with the second embodiment of the present invention operates in the following manner.

Referring to FIG. 3, the sensor 203 measures the amount of the waste toner stored in the waste toner container 200. When the amount of the waste toner reaches a predetermined amount, the driving unit 425 is operated by the controlling unit (not shown). As a result, the screw 424 rotates, thus transporting the waste toner to the temporary waste toner container 421.

When the amount of the waste toner stored in the temporary waste toner container 421 exceeds a predetermined amount, the sensor 422 senses the excess of toner. Then, the driving unit 427 is operated by the controlling unit (not shown) to transport the waste toner to the waste toner developing unit 410.

When the amount of the waste toner stored in the waste toner developing unit 410 exceeds a predetermined amount, the sensor 411 senses the excess of toner. As a result, the driving unit 427 is stopped by the controlling unit (not shown), thus halting the transportation of the waste toner.

The electrostatic latent image formed on the photoreceptive drum 120 is developed using the waste toner developing unit 410 in the same manner as described reference to developing units 1310, 1320, 1330, and 1340. The developing process of the waste toner developing unit 410 is not illustrated in the drawings.

As mentioned above, in an image forming apparatus including a waste toner reusing device in accordance with embodiments of the present invention, waste toner stored in a waste toner container is not discarded. The waste toner is transported to a waste toner developing unit to develop latent images formed on a photoreceptive drum. Therefore, the waste toner can be reused for things such as print testing. Reusing waste toner reduces toner consumption and thus cuts costs.

While the present invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. An image forming apparatus having at least one photoreceptive unit and an intermediate transfer medium, the image forming apparatus comprising:
a waste toner container for storing waste toner removed from at least one of the photoreceptive unit and the intermediate transfer medium; and
a waste toner reusing device for reusing the waste toner stored in the waste toner container to develop a latent image formed on the photoreceptive unit.

2. The image forming apparatus of claim 1, further comprising a plurality of developing units to develop the electrostatic latent image formed on the photoreceptive unit into a color image,
wherein the waste toner reusing device reuses the color waste toner removed from the photoreceptive unit and the intermediate transfer medium to form an image.

3. The image forming apparatus of claim 2, wherein the waste toner reusing device comprises a waste toner developing unit providing the waste toner to the photoreceptive unit to develop the electrostatic latent image formed thereon, and a transporting unit transporting the waste toner from the waste toner container to the waste toner developing unit.

4. The image forming apparatus of claim 1 , wherein the waste toner reusing device comprises a waste toner developing unit providing the waste toner to the photoreceptive unit to develop the electrostatic latent image formed thereon, and a transporting unit transporting the waste toner from the waste toner container to the waste toner developing unit.

5. The image forming apparatus of claim 3, wherein the transporting unit comprises:
a connecting unit connecting the waste toner container to the waste toner developing unit and having a screw to transport the waste toner; and
a driving unit to rotate the screw.

6. The image forming apparatus of claim 5, wherein the connecting unit further comprises a temporary waste toner container for temporarily storing the waste toner transported from the waste toner container.

7. The image forming apparatus of claim 6, wherein the temporary waste toner container and the waste toner developing unit each comprise a sensor.

8. A method of reusing waste toner of an image forming apparatus, comprising:
transporting waste toner stored in a waste toner container to a waste toner developing unit; and
developing a latent image formed on a photoreceptive drum by using the waste toner contained in the waste toner developing unit.

9. The method of claim 8, wherein the image forming apparatus comprises a transporting unit including a connecting unit connecting the waste toner container to the waste toner developing unit and having a screw therein to transport the waste toner, and a driving unit rotating the screw.

10. The method of claim 8, wherein the image forming apparatus further comprises a temporary waste toner container temporally storing the waste toner transported from the waste toner container.

11. The method of claim 10, wherein the temporary waste toner container and the waste toner developing unit each comprises a sensor.

12. The method of claim 8, wherein the waste toner is formed by mixing a plurality of color toners and reused.
